(19) United States
(12) Patent Application Publication
(10) Pub. No.: US 2008/0306924 A1
(43) Pub. Date: Dec. 11, 2008

(54) MOBILE TELEPHONE OBJECT LOOKUP AND IDENTIFICATION

(76) Inventors: MICHAEL A. PAOLINI, Austin, TX (US); Colin Parris, Somers, NY (US); Omar S. Pena, Pflugerville, TX (US)

Correspondence Address: Greg Goshorn, P.C., 9600 Escarpment, Suite 745-9, AUSTIN, TX, 78749, US

(21) Appl. No.: 11/758,065

(22) Filed: Jun. 5, 2007

(51) Int. Cl. G06F 17/30

(52) U.S. Cl. 707/4; 707/E17.015

(57) ABSTRACT

Provided is a system and method for providing an information retrieval service on a mobile computing device such as a wireless computer or cellular telephone. The user of a mobile computing device provides vocal, visual or textual data to the service provider. The service scans a transmitted data to convert the data into a digital form and the data is converted into a text file. The service provider performs analytical computations on the data in the text file and, using context and preference rules, produces and transmits information of value to the user. In addition, the service may request additional information from the user for the purpose of better servicing the query. A query to the claimed service may be modified based upon configuration information stored with respect to a particular user or based upon previous queries from the particular user.

### TECHNICAL FIELD

The present invention relates generally to an information retrieval service and, more specifically, to an information lookup service that provides information based upon data from a mobile telephone or other computing device.

### BACKGROUND OF THE INVENTION

Over the past several decades, mobile telephones, or cell phones, and wireless computing devices have become ubiquitous. In the year 2003 alone over seventy-five million cell phones were shipped to consumers. Both cell phones and mobile computers have become smaller, more powerful and able to provide increasingly sophisticated services and functionality. Many applications have been developed to take advantage of the large numbers, portability and processing power of these devices. Today, many mobile devices include cameras, keyboards and other accessories to increase their utility.

One example of a service available to users of mobile telephone and computing devices is a music recognition service provided by some foreign and domestic cellular service providers. A user enters a designated code, e.g. “#43,” on the keypad of a cell phone, presses the send button and, after a connection to the service is established, holds the telephone's microphone to a music source for fifteen seconds or so. The service evaluates the music source, determines the song and the artist and sends a text message to the user with the names of the song and the artist. Typically, a small charge is added to the monthly bill of the user for this service although it could also be provided as a free feature of a particular cellular service provider.

Other examples of services available to users of mobile computing devices and telephones include music streaming services that enable a user to tune into any particular music stream such as a radio station and services that enable users to download maps, ring tones and specific songs for playback. Another example is a service that reads special bar codes displayed in conjunction with billboards and performs a lookup and display of information stored in conjunction with the bar code. What is needed is a service that provides a more flexible information retrieval that includes more generalized reference needs than currently available.

### SUMMARY OF THE INVENTION

Provided is a system and method for providing an information retrieval service on a mobile computing device such as, but not limited to, a wireless computer or cellular telephone. The user of a mobile computing device provides information to the service provider. One example described throughout the Specification regards information concerning a bottle of wine or a list of wines although there is no limit on the type of information that may benefit from the techniques of the claimed subject matter.

With respect to a bottle of wine, the user transmits from a cell phone an image of the label of a particular bottle of wine and/or a textual or vocal description of the bottle. The service scans or otherwise processes the transmitted data to convert the data into a digital form. For example, optical character recognition (OCR) is employed to convert the information displayed on the label into a text file. The service provider performs analytical computations on the data in the text file and, using context and preference rules, produces information of value to the user. For example, the service provider may determine the type of wine, the brand, the year, the region in which the grapes were grown and a rating number for the wine from a commercial wine rating service. The type, brand, year, grape and rating information is then transmitted back to the user in the form of a text message.

Other examples of services provided by the claimed subject matter include, but are not limited to, the transmission of information on the label of a medicine bottle and billboards. With respect to medicine bottles, a user might transmit either an image or a text description of the label and receive information relating to dosage or potential adverse effects the medicine may have with other medications the user is taking. This service may be particularly useful to a user who has trouble reading the label of a bottle. With respect to a billboard, the display does not even have to be in the user's language. If the user is in a foreign country, the service can provide a language translation. In addition, a query may be directed to information displayed on a television or LCD screen.

The service may request additional information from the user for the purpose of better servicing the query. For example, if the OCR is unable to resolve the image, a query may be sent to the user to resolve the character recognition problem. If the service uncovers more information than can be transmitted efficiently in a text message, a message may be transmitted to the user requesting additional information to further restrict the original query.

A query to the claimed service may be modified based upon configuration information stored with respect to a particular user or based upon previous queries from the particular user. For example, a user may specify via a configuration file that the only information transmitted in response to a query corresponding to a wine list is a rating corresponding to the individual wines on the list. This limitation may also be determined based upon previous queries that typically restricted the information returned to the user to ratings information.

This summary is not intended as a comprehensive description of the claimed subject matter but, rather, is intended to provide a brief overview of some of the functionality associated therewith. Other systems, methods, functionality, features and advantages of the invention will be or will become apparent to one with skill in the art upon examination of the following figures and detailed description.

### BRIEF DESCRIPTION OF THE FIGURES

A better understanding of the present invention can be obtained when the following detailed description of the disclosed embodiments is considered in conjunction with the following figures.

FIG. 1 is a block diagram of one example of a computing and communication system architecture that supports the claimed subject matter.

FIG. 2 is a block diagram a cellular telephone employed as an example of in one implementation of the claimed subject matter.

FIG. 3 is a block diagram of a context-based information system (CBIS) that implements the claimed subject matter.

FIG. 4 is a flowchart of an Execute CBIS process that implements the claimed subject matter.

FIG. 5 is a flowchart of a Process Input process that executes in conjunction with Execute CBIS process of FIG. 4.

FIG. 6 is a flowchart of a Process Query process that executes in conjunction with Process Input process of FIG. 5 and Execute CBIS process of FIG. 4.

### DETAILED DESCRIPTION OF THE FIGURES

Although described with particular reference to a cellular telephone, the claimed subject matter can be implemented in any communication technology (IT) system in which context-based information retrieval is desirable. Those with skill in the communication and computing arts will recognize that the disclosed embodiments have relevance to a wide variety of communication and computing environments in addition to those described below. In addition, the methods of the disclosed invention can be implemented in software, hardware, or a combination of software and hardware. The hardware portion can be implemented using specialized logic; the software portion can be stored in a memory and executed by a suitable instruction execution system such as a microprocessor, personal computer (PC) or mainframe.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic or semiconductor system, apparatus or device. Memory an recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

One embodiment, in accordance with the claimed subject, is directed to a programmed method for providing a context-based information retrieval system. The term “programmed method”, as used herein, is defined to mean one or more process steps that are presently performed; or, alternatively, one or more process steps that are enabled to be performed at a future point in time. The term “programmed method” anticipates three alternative forms. First, a programmed method comprises presently performed process steps. Second, a programmed method comprises a computer-readable medium embodying computer instructions, which when executed by a computer performs one or more process steps. Finally, a programmed method comprises a computer system that has been programmed by software, hardware, firmware, or any combination thereof, to perform one or more process steps. It is to be understood that the term “programmed method” is not to be construed as simultaneously having more than one alternative form, but rather is to be construed in the truest sense of an alternative form wherein, at any given point in time, only one of the plurality of alternative forms is present.

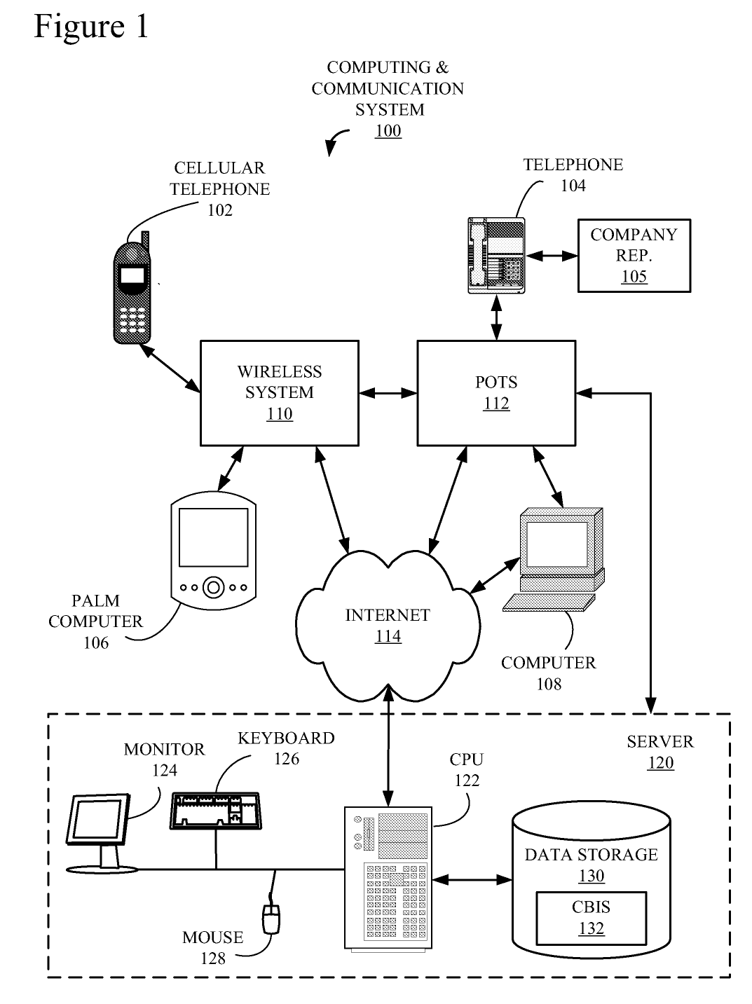

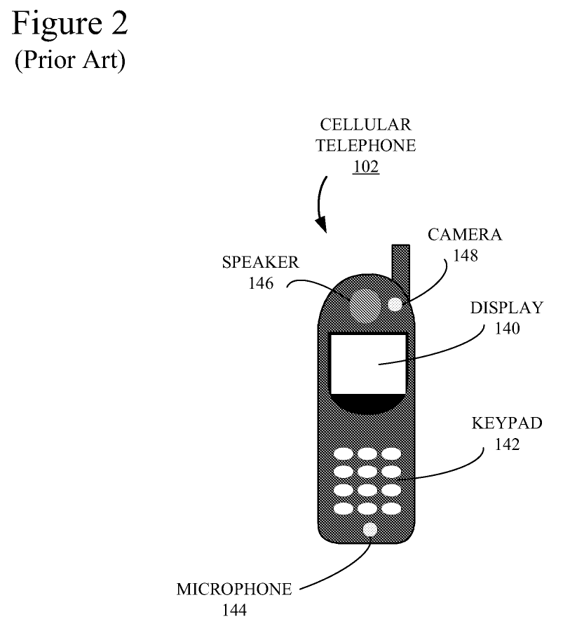

Turning now to the figures, FIG. 1 is a block diagram of one example of a computing and communication system architecture 100 that supports the claimed subject matter. Architecture 100 includes several communication and computing devices, including a cellular telephone, or cell phone, 102, a standard telephone 104, a handheld, or palm, computer 106 and a desktop computer 108. Each of these devices is typically available in the commercial market and should be familiar to those with experience in the communication and computing arts. In the following description, telephone 104 provides communication capabilities to a customer representative (rep.) 105. The disclosed techniques may be implemented on these or many other typical devices. Throughout this Specification, cellular telephone 102, described in more detail below in conjunction with FIG. 2, is employed for the purpose of illustrating the claimed subject matter although the claimed subject matter applies equally well to other communication and computing devices.

Each of devices 102, 104, 106 and 108 is coupled to one or more communication mediums, which in this example include a wireless system 110, a plain old telephone service (POTS) 112 and the Internet 114. Also coupled to Internet 114 and POTS 112 is a server computer 120. Server 120 includes a central processing unit (CPU) 122, which is coupled to a monitor 124, a keyboard 126 and a mouse 128, which together facilitate human interaction with server 120. Also included in server 120 and attached to CPU 122 is a data storage component 130, which may either be incorporated into CPU 122 i.e. an internal device, or attached externally to CPU 122 by means of various, commonly available connection devices such as but not limited to, a universal serial bus (USB) port (not shown). Stored on data storage 130 is a context-based information system (CBIS) 132 that implements the claimed subject matter. CBIS 132 is described in more detail below in conjunction with FIGS. 2-6.

In this example, cellular telephone 102 and palm computer 106 are communicatively coupled to server 120 via wireless system 110 and Internet 114. Telephone 104 is coupled to server 120 via POTS 112 which has two connections, one via Internet 114 and one via a direct connection. Computer 108 is coupled to server 120 via both POTS 108 and Internet 114. The claimed subject matter may be implemented on many types of communication media. The examples of FIG. 1 are used for illustration purposes only and are not intended to limit the claimed subject matter.

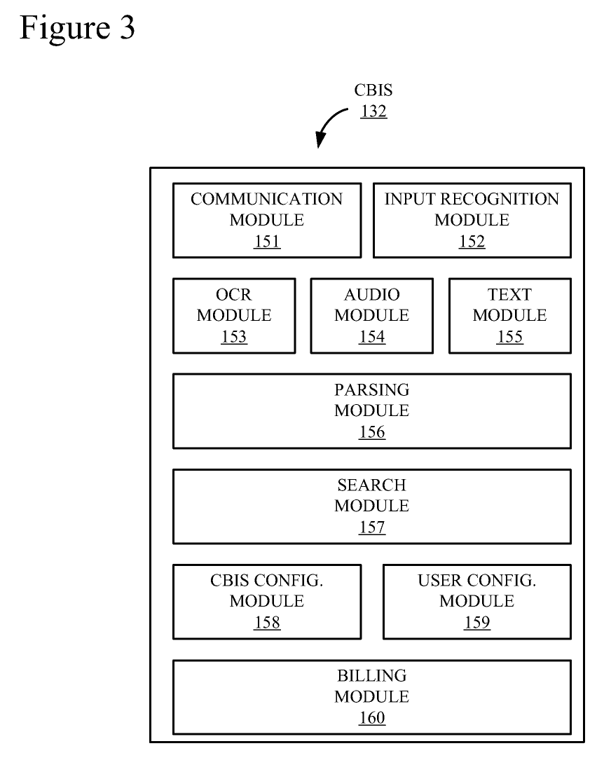

FIG. 2 is a block diagram of cellular telephone 102 (FIG. 1) employed as an example in the following description of one implementation of the claimed subject matter. Cellular telephone 102 is typical of many mobile telephones commercially available. Cellular telephone includes a display 140, a keypad 142, a microphone 144, a speaker 146 and a camera 148. The interaction of components 140, 142, 144, 146 and 148 with respect to the claimed subject matter is explained in more detail below in conjunction with FIGS. 3-6. In addition, components such as components 140, 142, 144, 146 and 148 are found on many computing and communication devices such as, but not limited to, telephone 104 (FIG. 1), palm computer 106 (FIG. 1) and computer 108 (FIG. 1). As explained above, the claimed subject matter is applicable to many types of communication and computing devices, many of which include some, all or similar components such as components 140, 142, 144, 146 and 148.

In this example, cellular telephone 102 is able to transmit and receive data in text, audio and visual formats. For example, cellular telephone 102 may employ Multimedia Messaging Service (MMS) that allows a user to send and receive messages that include images, audio, video and rich text.

FIG. 3 is a block diagram of context-based information system (CBIS) 132, first introduced above in conjunction with FIG. 1, in more detail. CBIS 132 includes a communication module 151, an input recognition module 152, an optical character recognition (OCR) module 153, a voice module 154, a text module 155, a parsing module 156 a search module 157, a CBIS configuration module 158, a user configuration module 159 and a billing module 160.

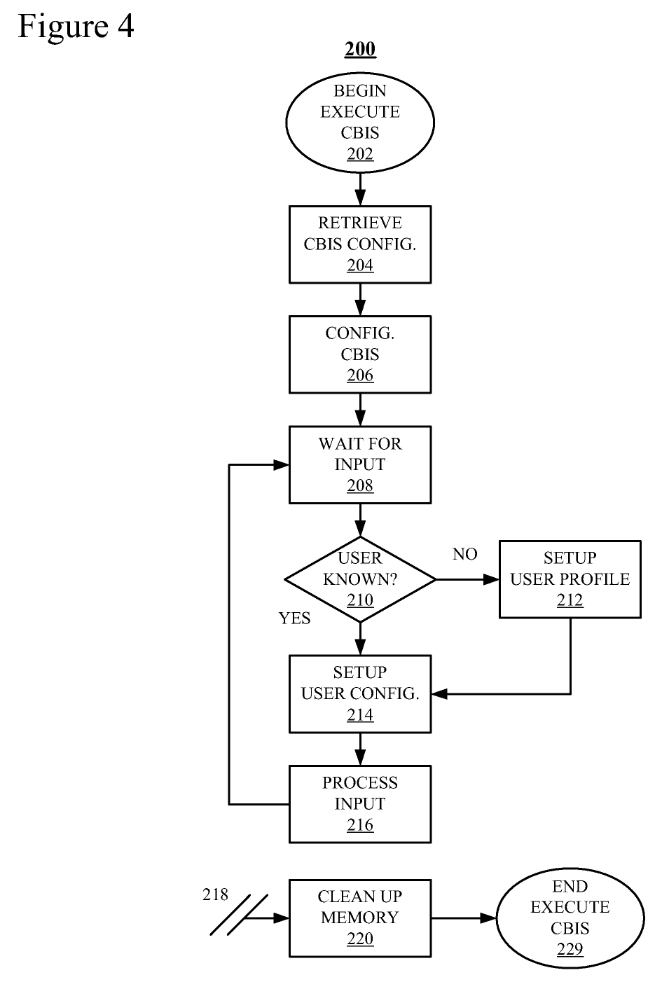

Functionality associated with each of modules 151-160 is described in detail below in conjunction with FIGS. 4-6. Briefly, communication module 151 executes task associated with input and output received from and transmitted to devices such as cellular telephone 102 (FIGS. 1 and 2). In addition, module 151 handles communication with data sources (not shown) that are searched to answer queries associated with the claimed subject matter. Input recognition module 151 identifies the format of queries received by CBIS 132. In the following examples, a query is transmited in a MMS format that may include any or all of a scanned image, vocal (or audio) data, or a text file, although other formats are possible.

OCR module 153, audio module 154 and text module 155 translate images, audio information or text information, respectively, depending upon the format or formats identified by input recognition module 152, into a standardized format for processing by CBIS 132. In the following example, the standardized format is a text file. Parsing module 156 takes standardized input generated by OCR module 153, audio module 154 and text module 155 and determines, based upon general context clues, the information requested. The context includes, but is not limited to, such information as the requesting device, a GPS location of the requesting device, the time, surrounding devices and both user and CBIS 132 defined configuration options. As explained below in conjunction with FIGS. 4-6, CBIS 132 may require additional information to determine the relevant information that is requested. In that case, module 156 transmits a request to the requesting party for additional information.

Once parsing module 156 has determined the appropriate query, search module 157 retrieves the relevant information. Information may be retrieved from any number of sources such as a database (not shown) located on data storage 130 (FIG. 1) or elsewhere or from publicly available information sources such as Wikipedia.com, published by Wilipedia Foundataion, Inc., a Florida not-for-profit corporation, or from information accessible by an Internet search engines such as Google, provided by Google, Inc. of Mountain View, Calif.

CBIS configuration module 158 stores information relating to the setup and operation of CBIS 132, including, but not limited to, data source locations, user interface screens and user interface default information. This information includes both context and preference rules. Finally, user configuration module 159 stores information related to specific users, including, but not limited to, data concerning setup parameters, login and password information, context information such as scheduling and geographical information, types of devices typically employed by the user, results of previous queries, preferred user interface parameters and so on. Although only one user configuration block 159 is illustrated, in an alternative embodiment, CBIS 132 stores multiple modules 159, each module 159 corresponding to a specific user. In an alternative embodiment, some user configuration information may be stored on user devices in the form of cookies, which should be familiar to those with skill in the computing arts.

Billing module 160 is responsible for maintaining records related to the charging for services related to CBIS 132. For example, CBIS 132 made be configured to access a specific fee for each request a user makes for information or fees made be based upon the amount of data transmitted. Each user may also have access to a limited number of searches for a fixed monthly rate. In addition, billing module 160 may access fees related to various third party vendors to whom a particular user desires access. For example, using the example of retrieving information concerning a bottle of wine, a user may select to receive information form the Wine Spectator and be accessed a access fee for that particular service. The functionality of each of modules 151-160 is also explained below in conjunction with the flowcharts of FIGS. 4-6.

FIG. 4 is a flowchart of an Execute CBIS process 200 that implements the claimed subject matter. Logic associated with process 200 is stored on data storage 130 (FIG. 1) and executes on CPU 122 (FIG. 1) as an implementation of CBIS 132 (FIGS. 1 and 3). The following description of process 200 is illustrated with a representative request for information from cellular telephone 102 (FIGS. 1 and 2).

Process 200 starts in a “Begin Execute CBIS” block 202 and proceeds immediately to a “Retrieve CBIS Configuration (Config.)” block 204. During block 204, process 200 retrieves data stored in CBIS configuration module 146 (FIG. 3), loading the data into volatile memory (not shown) associated with CPU 122 (FIG. 1) to facilitate processing. As explained above in conjunction with FIG. 3, CBIS configuration data includes information such as, but not limited to, data source locations, user interface screens and user interface default information. During a “Configure CBIS” block 206, process 200 employs the configuration data retrieved during block 204 to initialize CBIS 132 for execution on CPU 122.

During a “Wait for Input” block 208, process 200 enters a sleep state to wait for a request for information from a user on a device such as cellular telephone 102, telephone 104 (FIG. 1), palm computer 106 (FIG. 1) or computer 108 (FIG. 1). In the following example, the request for information is a query about wine received from a user on cellular telephone 102 that takes the form of a scanned image of the label generated by camera 148 (FIG. 2). Other examples of query formats include a text description, a vocal description or some combination of visual, audio and textual formats. It should be understood that any particular query might include multiple formats.

During a “User Known?” block 210, process 200 determines whether or not the user who transmitted the query received during block 208 is a known, or registered user. A particular user is verified as a known user based upon the existence of information in user configuration module 159 (FIGS. 1 and 3) corresponding to the particular user. If the user is not known, i.e. there is no corresponding information in user configuration module 159, process 200 proceeds to a “Setup User Profile” block 212 during which process 200 generates a user interface (GUI) (not shown) that enables the unknown user to register for the information service by entering the appropriate information. In an alternative embodiment, a potential customer may register for the service provided by the claimed subject matter via a website on Internet 114 (FIG. 1), accessing the website via computer 108 (FIG. 1).

One example of a GUI that enables a user to query for information on wine may look as follows:
Main Menu—Select one of the following, press pound to return to previous menu.
   1) Reviews—1) Wine Spectator; 2) Wine Advocate; 3) Wine Enthusiast.
      If the user selects #3, the Wine Enthusiast, a new prompt is displayed as follows:
You selected Wine Enthusiast, please select:
   1) Methodology; 2) Point Scale; 3) Overall score.

The information entered during registration is used to update user configuration module 159. In addition, billing module 160 (FIG. 3) may note the request to access a particular service or publication and charge the user a fee accordingly. Once the user has registered during block 212 or corresponding information is located in user configuration block 159 during block 210, process 200 proceeds to a “Setup User Configuration (Config.)” block 214. During block 214, process 200 configures 132 as specified in the user configuration module 159.

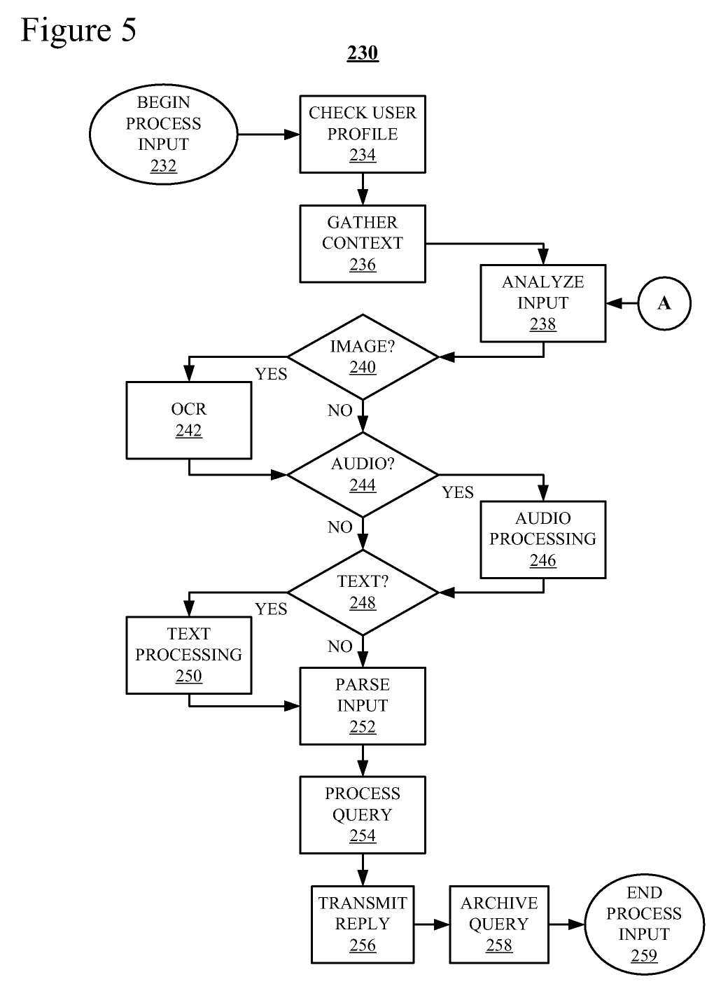

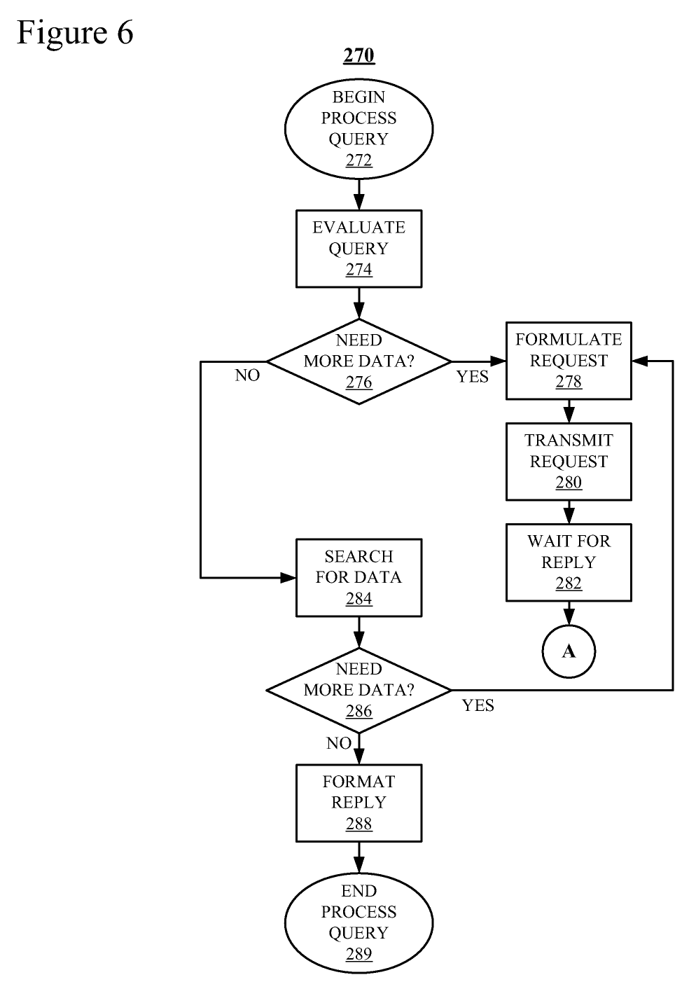

During a “Process Input” block 216, process 200 executes logic to determine an appropriate response to the query received during block 208. Processing associated with block 216 is described in more detail below in conjunction with FIGS. 5 and 6. Once a query has been processed during block 216, process 200 returns to block 208 during which process 200 waits for another query to be received and processing continues as described above.

Once initiated, process 200 typically executes until intentionally halted or server 120 is powered down. In either case, an asynchronous interrupt 218 is generated to initiate a shut down procedure that includes a “Clean Up Memory” block 220. During block 220, process executes steps to gracefully shutdown process 200 including, but not limited to, cleaning up any memory associated with the execution of process 200. Finally, process 200 proceeds to an “End Execute CBIS” block 229 in which process 200 is complete.

FIG. 5 is a flowchart of a Process Input process 230 that executes in conjunction with Execute CBIS process 200 introduced above in conjunction with FIG. 4. Process 230 corresponds to Process Input block 216 (FIG. 4) of process 200. Process 230 starts in a “Begin Process Input” block 232 and proceeds immediately to a “Check User Profile” block 234. During block 232, process 230 evaluates information included in the user configuration module 159 (FIGS. 1 and 3) corresponding to the user who initiated the current query. As explained above module 159 is retrieved during user known? block 210 (FIG. 4).

During a “Gather Context” block 236, process 230 collects any information that may be related with the query, both information stored in user configuration module 159 and information transmitted with the query itself. For example, if the query is transmitted from cellular telephone 102 (FIGS. 1 and 2), information included in the query may include the current geographical location of telephone 102 that would enable CBIS 132 to recommend a nearby store where a particular bottle of wine may be purchased. Other examples of context information include, but are not limited to, data on past queries by the particular user, specific user preferences, existence of frequent-user accounts and weather information. For instance, if a user typically only requests wine ratings, CBIS 132 may limit a reply to ratings information and prompt the user to specify any other information that may be desired. In another example, the query is a voice message indicating a need to locate a hotel room, an image of an “Austin City Limit” sign to indicate a location, and a known preference of the user to hotels of a particular brand. Historical query data may also be employed to set the order in which information is displayed.

During an “Analyze Input” block 238, input recognition module 152 (FIGS. 1 and 3) determines the format of the query. Three examples are visual, audio and textual formats. Of course, other formats are possible. For the sake of simplicity, the following examples are restricted to visual, audio and textual formats. Block 238 is also entered via a Transition point A, which is explained in more detail below in conjunction with FIG. 6. Briefly, transition point A is a path taken when a Process Query process 270 (see FIG. 6) determines that the query received during block 208 does not include enough information to effectively formulate a response and that additional user input is required.

During an “Image?” block 240, process 240 determines whether or not the query analyzed during block 238 includes a component in a visual format, e.g. a digital image. If so, process 230 proceeds to an “Optical Character Recognition (OCR)” block 242. During block 242, OCR module 153 (FIGS. 1 and 3) converts a received image into a textual file by employing techniques that should be familiar to those with skill in the computing arts. Once processing of block 242 is complete or, if during block 240, process 230 determines that the query does not include a component in a visual format, control proceeds to an “Audio?” block 244 during which process 230 determines whether or not the query includes a component in an audio format, e.g. a spoken question. If so, process 230 proceeds to an “Audio Processing” block 246. During block 246, audio module 154 (FIG. 3) received audio into a textual file by employing techniques that should be familiar to those with skill in the computing arts.

Once processing of block 246 is complete or, if during block 244, process 230 determines that the query is not in an audio format, control proceeds to a “Text?” block 248 during which process 230 determines whether or whether or not the query analyzed during block 238 includes a component in a textual format, e.g. a typed question. If so, process 230 proceeds to a “Text Processing” block 250 during which, text module 155 (FIG. 3) reformats a received text file into a format compatible with CBIS 132. It should be understood that audio, visual and textual files are only examples of the types of formats that may be processed by the disclosed techniques and that the particular process and order described for the identification and processing of different formats is used only for illustrative purposes.

During a “Parse Input” block 252, parsing module 156 (FIG. 3) analyzes the query, which was formatted into a standardized format in one or more of blocks 242, 246 or 250, to determine exactly what information the user is requesting. For example, if the query includes an image of the label of a wine bottle, module 156 would determine the information relating to the wine in the bottle was requested. This determination is based upon the textual information generated from the image during block 242, data in user configuration module 159 and context gathered during block 236.

During a “Process Query” block 254, process 230 determines an appropriate response to the current query. Block 254 is described in more detail below in conjunction with FIG. 6. Once a replay to the current query has been generated, process 230 proceeds to a “Transmit Reply” block 256 during which the response generated during block 254 is transmitted to the device from which the query was initiated, which in this example is cellular telephone 102.

In an alternative embodiment, rather than transmitting the response to the device from which the query originated, a response may be place on a web portal (not shown) and retrieved either with the originating device or another device via the Internet 114 (FIG. 1). In another embodiment, a response might involve the incorporation of data into another application. For example, a user may take an image of a flyer advertising the date and time of a lecture and the transformed date and time information, rather then being returned to the device from which the query originated, is transmitted to and stored in a calendar program as an entry to remind the user to attend the lecture. Such a calendar program, incorporated into the claimed subject matter, could then transmit a reminder to the user at an appropriate time.

During an “Archive Query” block 258, process 230 saves both the query and the result in data storage 130 in conjunction with user configuration module 159 and the user who initiated the query. The archiving of data may take the form of Internet 114 enabled files that the user is able to access and share with other users. Such data could be organized in a tree structure and indexed to enable easy lookup. Such a storage structure enables a user to access a subset of the information immediately and yet provide more detailed information later such as when the user has access to a different device better suited to examining additional data. In addition, the archive is able to store user-generated or group-generated comments. For example, if the user drinks a particularly good bottle of wine, a query is generated based upon an image of the label and the user adds comments to the results of the query that make note of the user's opinion. Context information may also be stored with the results. For example, if cellular telephone 102 is the source of the query, GPS or other location data may be sorted in conjunction with the results.

In another embodiment, data is stored in data storage 130 for later processing. For example, if the received query consists of an image of a box or plate of food, the processing of the query may involve a calculation of the total calories of the food, which is then stored in data storage 130 with a listing of the food items to enable the user to maintain a dietary log. Finally, process 230 proceeds to an “End Process Input” block 259 in which process 230 is complete.

FIG. 6 is a flowchart of a Process Query process 270 that executes in conjunction with Process Input process 230 of FIG. 5 and Execute CBIS process 200 of FIG. 4. Process 270 corresponds to Process Query block 254 (FIG. 5). Process 270 starts in a “Begin Process Query” block 272 and proceeds immediately to an “Evaluate Query” block 274. During block 274, process 270 evaluates the query received during Wait for Input block 208 (FIG. 4) for completeness. The check for completeness involves both the query and the context associated with the query.

During a “Need More Data?” block 276, process 270 determines whether or not the received query contains enough information so that the query can be processed. If not, process 270 proceeds to a “Formulate Request” block 278 during which process 270 generates a message for transmission to, in this example, cellular telephone 102 (FIGS. 1 and 2). Simply stated, the message includes a request to transmit more information so that process 270 may effectively process the query. For example if a transmitted label is obscured such that the vintage year cannot be resolved, the user may be transmitted a text message that states, “Vintage year not recognized. Please enter type ‘1’ if year is 1982 or ‘2’ if year is 1883.” During a “Transmit Request” block 280, process 270 transmits the message generated during block 278 to cellular telephone 102.

During a “Wait For Reply” block 282, process 270 pauses to enable the user of cellular telephone 102 to formulate and transmit a reply to the request for additional information. Once a reply is received, control proceeds to a transition point A, returning control to Analyze Input block 238 of Process Input process 230, described above in conjunction with FIG. 5. It should be noted that transition point A enters process 230 at logic for converting the returned input from a visual, audio and/or textual format into a standardized textual format. In other words, regardless of the format of the original received query, any clarification query and corresponding response may be in any format. For example, if the original query is a scanned image of the label of a wine bottle with the vintage year obscured, the additional query and corresponding reply may be transmitted in the form of text messages.

If during block 276, process 270 determines the received query is complete, process 270 proceeds to a “Search For Data” block 284. During block 284, search module 157 (FIG. 3), using information sources listed in CBIS configuration module 158 (FIG. 3), retrieves information related to the query. There are many types of information that may be retrieves in association with a particular query. For example, query about a particular wine may also retrieve information about specials on the wine at retail outlets in the vicinity of the device from which the query originated. A determination of the vicinity may be based upon GPS information, the user's billing zip code and so on. A response may include such items as published sales, coupons and rebates for a particular item.

Once data has been retrieved, process 270 proceeds to a second “Need More Data?” block 286 during which process 270 determines whether or not the query generated either enough of too much data. In the case of too much data, the information set retrieved must be small enough to transmit to cellular telephone 102. In other words, not only must the received query be complete, which is determined during block 276, the query must include some information and be specific enough to prevent too much data form being generated for transmission to cellular telephone 102. If the generated data set is either too small or too large, process 270 proceeds to block 278 and processing continues as described above. For example, a request of additional parameters may take the form of a message that states, “This is a bottle of wine. Do you want me to 1) Find prices; 2) List food pairings; 3) Give reviews: 4) Tell you about the vineyard; 5) Identify specials; 6) other.” An answer to the entry of the number ‘2’ may be a request for additional information such as “1) French; 2) Italian; or 3) Greek?” In other words the claimed subject matter provides the capability of context refinements to search requests.

Another example of a result set that enables refinements to the original query looks as follows:
Silver Oak Merlot; rated 95 by Wine Spectator; typically priced at $100 per bottle retail; $200 in restaurants; goes well with red meats and spicy foods.
There are additional notations made by you or people in your association, would you like to read them?
Do you want to be connected to a Silver Oak representative?
Do you want to order Silver Oak for delivery?
Do you want a list of similar wines?

If during block 286, process 270 determines that the data set is neither too small nor too large, control proceeds to a “Format Reply” block 288. During block 288, process 270 formats the retrieved data into a format as specified by CBIS configuration module 158 and user configuration module 159 (FIG. 3) for transmission to cellular telephone 102. For example, the reply may be configured as a text message for display on display 140 (FIG. 2 or an audio message generated by a voice synthesizer (not shown) delivered via speaker 146. Another possible reply method may be the posting of information on a web portal coupled to Internet 114 (FIG. 1) with a corresponding link transmitted to the user. Of course a reply may be any combination of the above methods. In an alternative embodiment, the query generates a request to a human such as customer representative 105 (FIG. 1) who calls the user on cellular telephone 102. For example, if a bottle of wine is recognized as a particular brand, a flag in CBIS configuration module 158 associated with that particular brand may route the query to a representative of that particular brand. Finally, control proceeds to an “End Process Query” block 289 in which process 270 is complete.

While the invention has been shown and described with reference to particular embodiments thereof, it will be understood by those skilled in the art that the foregoing and other changes in form and detail may be made therein without departing from the spirit and scope of the invention, including but not limited to additional, less or modified elements and/or additional, less or modified blocks performed in the same or a different order. As explained above, in addition to the described examples, other applications include, but are not limited to, the augmentation of information on such things product and medicine bottle labels and billboards. Services provided may include the translation of foreign languages.

We claim:

1. A method for providing a service, comprising:
receiving data acquired by a mobile user device;
producing a service configuration corresponding to a user of the mobile user device;
producing a query based upon the received data;
generating a query function based upon the query;
executing the query function;
receiving a result from the execution of the query function;
augmenting the result based upon the service configuration; and
returning the augmented result to the mobile user device.

2. The method of claims 1, the producing of the query comprising:
parsing the received data into voice, text and audio components; and
converting the voice, text and audio components into a standardized format.

3. The method of claim 1, the producing of the query comprising correlating context data with the received data.

4. The method of claim 3, the correlating of the context data comprising generating geographical location information corresponding to the mobile user device.

5. The method of claim 1, the returning of the augmented result, comprising:
configuring a webpage incorporating the augmented result; and
posting the webpage on the Internet.

6. The method of claim 1, the returning of the augmented result, comprising:
storing the augmented result in a data storage; and
transmitting a message to the mobile device indicating the augmented data is stored in the data storage.

7. The method of claim 1, the producing of a service configuration comprising storing user preferences corresponding to the user of the mobile user device.

8. A system for providing an information service, comprising:
a processor;
a memory coupled to the processor;
logic, stored on the memory for execution on the processor, for receiving data acquired by a mobile user device;
a service configuration stored on the memory;
logic, stored on the memory for execution on the processor, for generating a query function based upon the received data;
logic, stored on the memory for execution on the processor, for executing the query function;
logic, stored on the memory for execution on the processor, for receiving a result from the execution of the query function;
logic, stored on the memory for execution on the processor, for augmenting the result based upon the service configuration; and
logic, stored on the memory for execution on the processor, for returning the augmented result to the mobile user device.

9. The system of claims 8, the producing of the query comprising:
logic, stored on the memory for execution on the processor, for parsing the received data into voice, text and audio components; and
logic, stored on the memory for execution on the processor, for converting the voice, text and audio components into a standardized format.

10. The system of claim 8, the logic for producing of the query comprising logic for correlating context data with the received data.

11. The system of claim 10, the logic for correlating of the context data, comprising logic for generating geographical location information corresponding to the mobile user device.

12. The system of claim 8, further comprising a webpage incorporating the augmented result.

13. The system of claim 8, the logic for returning of the augmented result, comprising:
logic for storing the augmented result in a data storage; and
logic for transmitting a message to the mobile device indicating the augmented data is stored in the data storage.

14. The system of claim 8, the logic for producing of a service configuration comprising logic for storing user preferences corresponding to the user of the mobile user device.

15. A computer programming product for providing an information service, comprising:
a memory;
logic, stored on the memory for execution on a processor, for receiving data acquired by a mobile user device;
a service configuration stored on the memory;
logic, stored on the memory for execution on the processor, for generating a query function based upon the received data;
logic, stored on the memory for execution on the processor, for executing the query function;
logic, stored on the memory for execution on the processor, for receiving a result from the execution of the query function;
logic, stored on the memory for execution on the processor, for augmenting the result based upon the service configuration; and
logic, stored on the memory for execution on the processor, for returning the augmented result to the mobile user device.

16. The computer programming product of claims 15, the log for producing of the query comprising:
logic for parsing the received data into voice, text and audio components; and
logic for converting the voice, text and audio components into a standardized format.

17. The computer programming product of claim 15, the logic for producing of the query comprising logic for correlating context data with the received data.

18. The computer programming product of claim 17, the logic for correlating of the context data, comprising logic for generating geographical location information corresponding to the mobile user device.

19. The computer programming product of claim 15, the logic for returning of the augmented result, comprising:
logic for storing the augmented result in a data storage; and
logic for transmitting a message to the mobile device indicating the augmented data is stored in the data storage.

20. The computer programming product of claim 15, the logic for producing of a service configuration comprising logic for storing user preferences corresponding to the user of the mobile user device.
